(19) United States
(12) Patent Application Publication
(10) Pub. No.: US 2023/0398875 A1
(43) Pub. Date: Dec. 14, 2023

(54) METHOD FOR RETROFITTING VEHICLES WITH REGENERATIVE BRAKING

(71) Applicant: Phil Paull, Noblesville, IN (US)

(72) Inventor: Phil Paull, Noblesville, IN (US)

(21) Appl. No.: 18/091,360

(22) Filed: Dec. 29, 2022

Related U.S. Application Data
(60) Provisional application No. 63/424,460, filed on Nov. 10, 2022.
(60) Provisional application No. 63/347,589, filed on Jun. 1, 2022.

(51) Int. Cl. B60L 7/10

(52) U.S. Cl. CPC B60L 7/10; B60L 2200/28

(57) ABSTRACT

A vehicle fitted with a regenerative braking accessory, including a vehicle and a regenerative braking accessory operationally connected to the vehicle. The regenerative braking accessory further includes an axel, at least one wheel operationally connected to the axel, at least one electromagnetic brake assembly operationally connected to the axel, an electric motor operationally connected to the axel, a battery array operationally connected to the at least one electromagnetic brake assembly and to the electric motor, and an electronic controller operationally connected to the battery array, to the at least one electromagnetic brake assembly and to the electric motor.

### TECHNICAL FIELD

The present novel technology relates generally to the field of mechanical engineering, and, more particularly, to a method and apparatus for retrofitting and/or modularly adapting vehicles with an axel adapted for regenerative braking and electric motor propulsion assistance and batteries for storage and supply of electric energy.

### BACKGROUND

Rising fuel costs and the demand for increased efficiency has impacted both the consumer and the automotive industry. While new innovations such as regenerative braking are being increasingly applied to new vehicle designs, existing vehicles are limited to their original specifications.

Thus, there is a need for a system for increasing the fuel efficiency and power efficiency of existing vehicles. The present novel technology addresses this need.

### BRIEF DESCRIPTION OF THE DRAWINGS

FIG. 1 is a first perspective view of a first embodiment of the present novel technology, a retrofit system for adapting a vehicle with regenerative braking and electric motor assist.

FIG. 2 is a second perspective view of the embodiment of FIG. 1.

FIG. 3 is a third partial perspective view of the embodiment of FIG. 1.

FIG. 4 is a partial top plan view of the embodiment of FIG. 1.

FIG. 5 is a first perspective view of a second embodiment of the present novel technology, a retrofit system for adapting a large vehicle with regenerative braking and electric motor assist.

FIG. 6 is a is a second partial perspective view of the embodiment of FIG. 5.

FIG. 7 is a is a third partial perspective view of the embodiment of FIG. 5.

FIG. 8 is a is a bottom plan view of the embodiment of FIG. 5.

FIG. 9 is a bottom perspective view of a third embodiment of the present novel technology, a retrofit system for adapting a large vehicle with regenerative braking and electric motor assist with the retrofit wheels directly engaging the vehicle wheels.

### DETAILED DESCRIPTION

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

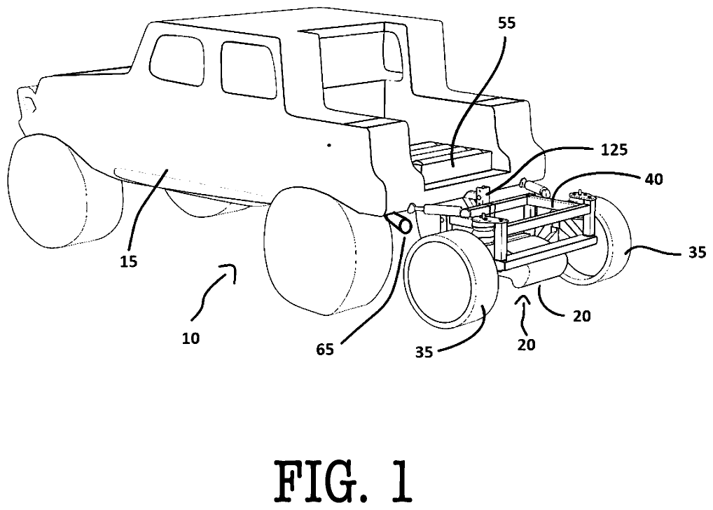

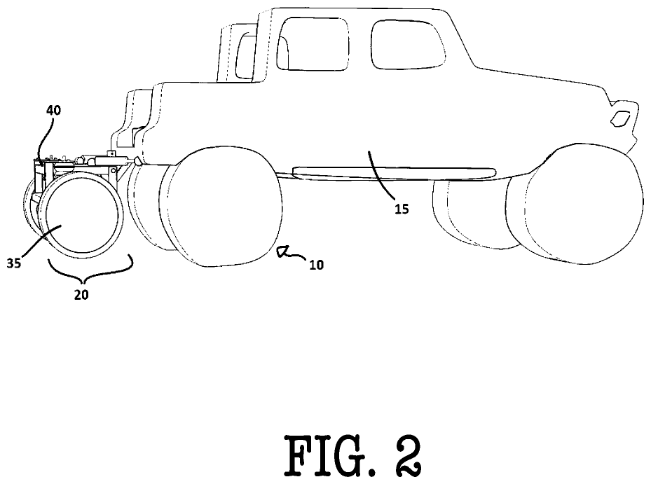

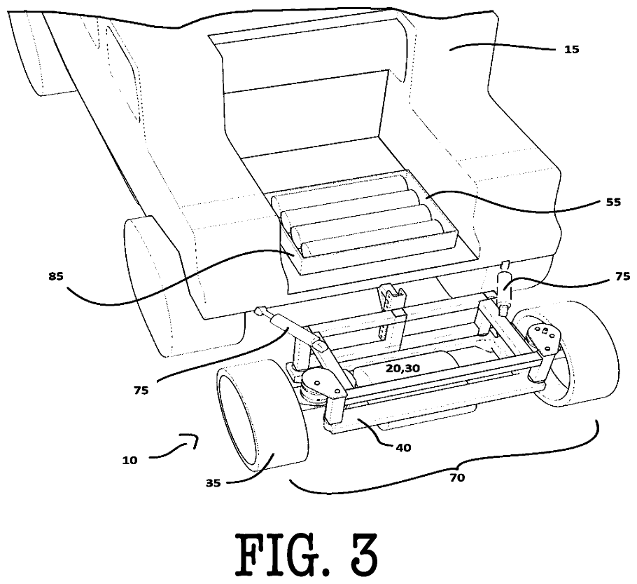

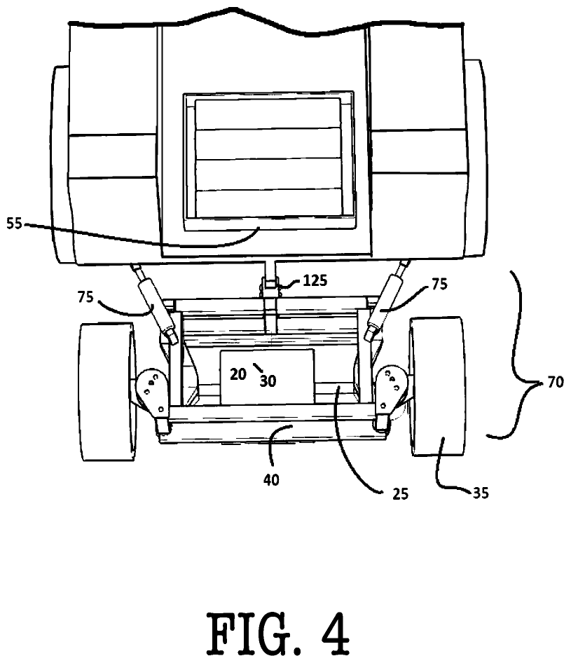

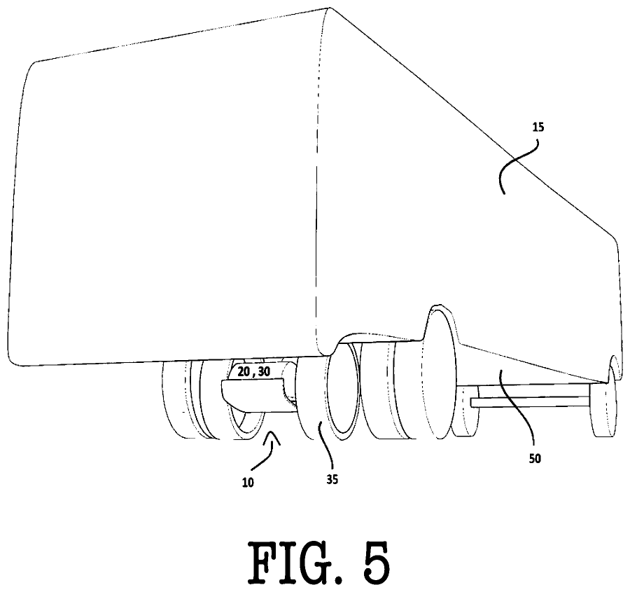

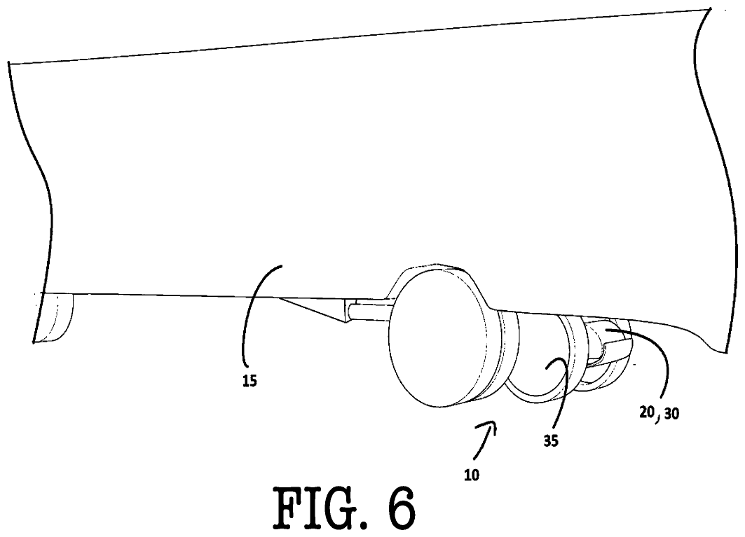

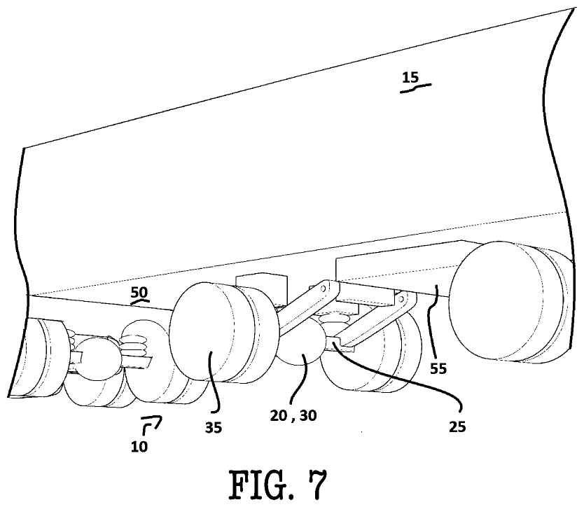

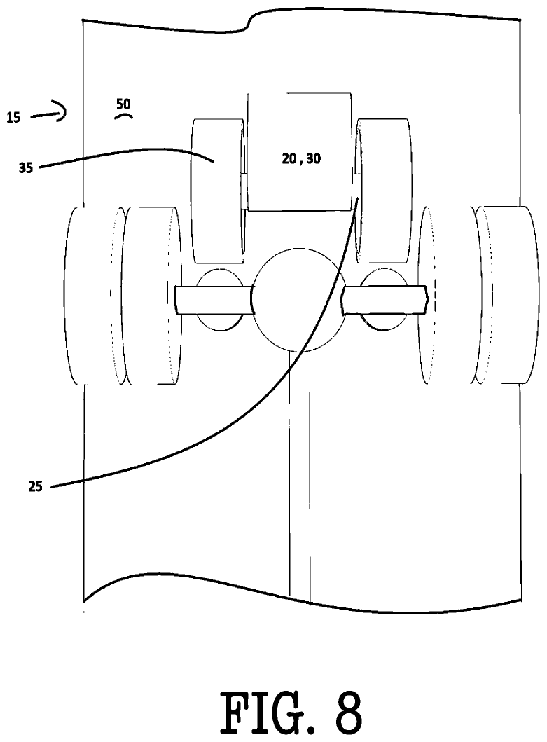

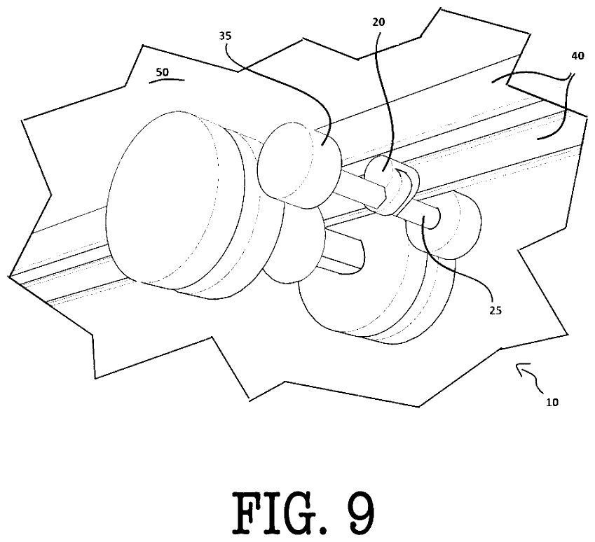

Embodiments of the present novel technology are illustrated in the attached drawing FIGS. 1-10, relating to a method, apparatus, and system 10 for retrofitting existing vehicles 15 with regenerative braking and electric motor drives 20 for actively capturing electrical energy during braking events, storing said energy, and using said energy to provide an electric motor 20 boost to the vehicle 15. The system 10 includes one or more axels 25 having an electric motor 20 operationally connected thereto and electromagnetic regenerative brakes 30 operationally connected to (one or more) wheels 35 disposed thereupon. In most embodiments, the electric motor 20 and the regenerative brakes 30 are unitary. The axels 25 may be permanently mounted to the vehicle 15, such as replacing one or more axel assemblies on a semi-truck, or may be temporarily and removeably replaceably connected to a vehicle 15, such as by a by connection to a structural framework 40 connectable to a trailer hitch or other connection point 45 on the vehicle 15. The axel(s) 25 may be mounted to the undercarriage 50 of a semi-trailer 15, along with the battery pack(s) and further may be pivotable such that the axel 25 may be pivoted toward the undercarriage 50 when not in use and may be pivoted to engage the road (deployed) when either energy generation, extra support for heavier loads, or both are required.

One or more rechargeable battery packs 55 are operationally connected to the regenerative braking portion 30 and to the electric motor portion 20 of each axel assembly The battery packs 55 are mounted to the vehicle 15 and are typically also accessible for independent charging, such as through a rectifier and/or adaptor operationally connected to the battery packs 55 and connectible to wall current and/or an electric vehicle charging station. The batteries 55 are typically connected as an array, although any viable configuration may be selected. The batteries 55 may be configured for access as a power source in the event of a power outage. Battery packs 55 may include a supplemental power source, such as (typically hydrogen) fuel cells or any other convenient electric power source.

A heat exchanger 60 is operationally connected to the vehicle exhaust 65, to the regenerative braking axel assembly 25, and to the battery pack 55, as well as to the external environment, so that in warm environments the regenerative braking axel assembly 25 may be cooled and in cold environments the battery pack 55 may be heated with heat supplied from the internal combustion engine exhaust from the vehicle 15.

In embodiments wherein the axel assembly 25 and/or battery pack(s) 55 are positioned on a trailer or platform 70 for connection behind (or beneath or in front of) a vehicle 15, such as a delivery van, a school bus, a semi-trailer, or the like, the trailer 70 is typically connected to the vehicle 15 by one or more fluidic (hydraulic, pneumatic) dampening members 75 to facilitate steering. The trailer 70 has at least one wheel 35, and more typically two wheels 35, and the steering control may be active (such as by manipulating the fluidic dampener(s) 75 via a pump 80 connected thereto) and controlled by the electronic controller 85, or control may be passive. Passive steering is essentially the trailer 70 following the vehicle 15, while active steering may be used to directionally apply power, to prevent the vehicle 15 from jack-knifing, stabilize the vehicle 15, assist the vehicle to increase safety, help crabwalk the vehicle 15 when stuck in the mud or like bad situation, provide a back-up steering system in case failure of the primary steering system, and the like. Both active and passive steering of the trailer/platform 70 increase the safety of the vehicle 15 and its passengers.

In some embodiments, the system 10 includes a sensor 90 for detecting how much braking is called for (such as a pressure or position sensor 90 operationally connected to the brake pedal 95), and a microprocessor 85 operationally connected to the sensor 90 and to the regenerative brakes 30 as well as to the standard brakes 100. For normal braking requirements, the microprocessor 85 will direct braking to the regenerative brakes 30, while during full braking requirements (or those that exceed the ability of the regenerative brakes the microprocessor 85 will engage the standard brakes 100 as well.

In some embodiments, instead of a separate, dedicated microprocessor 85, the sensor 90 is operationally connected to the vehicle's existing computer 85′, and a software patch 105 is provided to enable operation as described above.

In some embodiments, one or more axels 25 having regenerative brakes 30, one or more battery packs 55, a sensor 90, connection wire 93, a microprocessor 85 and/or software patch 105 and instructions 107 for installation of the same are provided as a kit 110.

In some embodiments, the OEM gas pedal 115 may be operationally connected the microprocessor 85 to establish a ‘regenerative mode’ of operation. The regenerative mode may be engaged and disengaged through commands to the microprocessor 85, such as via an electric switch, by voice command, or the like, wherein when the regenerative mode is engaged, release of the gas pedal 115 will automatically keep the engine in gear to generate electricity to recharge the batteries. As the gas pedal 115 is depressed, regeneration is paused and the vehicle 15 accelerates normally. In some embodiments, a separate gas pedal 120 dedicated is operationally connected to the microprocessor 85 for regenerative operation while the OEM gas pedal 115 remains unmodified.

### EXAMPLE 1

The assembly 10 may be operationally connected to the undercarriage 50 of a bus 15. The assembly 10 includes a support frame 40 to which an axel 25, a pair of wheels 35 operationally connected to the axel, regenerative brakes 30 operationally connected to the axel 25, a battery array 55 operationally connected to the regenerative brakes 30, an electric motor 20 operationally connected to the axel 25 and the battery array 55, a sensor 90 operationally connected to the wheel 35, and a microprocessor 85 operationally connected to the sensor 90, to the electric motor 20, to the OEM brake pedal 95, the OEM gas pedal 115, and to the regenerative brakes 30. In operation, when the brake pedal is engaged the microprocessor engages the regenerative brakes 30 to slow the vehicle 15 and charge the battery array 55. When the gas pedal 115 is engaged, the microprocessor 85 may engage the electric motor 20 if it is calculated that additional power is required beyond that provided by the vehicle's 15 internal combustion engine, or if a signal is sent to the microprocessor 85 to engage the electric motors 20.

### EXAMPLE 2

The bus 15 as described in EXAMPLE 1, but with the assembly 10 pivotably connected to the bus 15, such that the axel 25 and wheels 35 may be pivoted toward the undercarriage 50 when not in use and may be pivoted to engage the road when energy generation and/or extra power is required.

### EXAMPLE 3

The assembly of EXAMPLE 1, but with the microprocessor 85 operationally connected with the vehicle's 15 gas pedal 115 (or dedicated pedal 120), such that when engaged regeneration mode, letting up on the gas pedal 115 results in automatic regeneration to charge the batteries 55.

### EXAMPLE 4

The assembly 10 may be operationally connected to an automobile 15 such as via connection to a trailer hitch 125 or the like. The assembly 10 includes a support frame 40 as part of a trailer 70 that includes the axel 25 and at least one, and more typically a pair of wheels 35 are operationally connected thereto. The system further includes regenerative brakes 30 operationally connected to the axel 25, a battery array 55 operationally connected to the regenerative brakes 30, an electric motor 20 operationally connected to the axel 25 and the battery array 55, a sensor 90 operationally connected to the wheel 35, and a microprocessor 85 operationally connected to the sensor 90, to the electric motor 20, to the OEM brake pedal 95, the OEM gas pedal 115, and to the regenerative brakes 30. In operation, when the brake pedal 95 is engaged the microprocessor 85 engages the regenerative brakes 30 to slow the vehicle 15 and charge the battery array 55. When the gas pedal 115 is engaged, the microprocessor 85 may engage the electric motor 20 if it is calculated that additional power is required beyond that provided by the vehicle's 15 internal combustion engine, or if a signal is sent to the microprocessor 85 to engage the electric motors 20. The battery array 55 may be charges via connection of an electric power source to a charging port 130 operationally connected to the battery array 55.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I claim:

1. A method for fitting a vehicle with regenerative braking, comprising:
a) identifying a regenerative braking axel assembly that will fit the vehicle;
b) operationally connecting the regenerative braking axel to the vehicle;
c) operationally connecting a battery pack to the vehicle and to the regenerative braking axel;
d) operationally connecting a heat exchanger to a vehicle exhaust, to the regenerative braking axel assembly, and to the battery pack;
wherein the regenerative braking axel assembly further comprises:
an axel;
at least one electromagnetic brake assembly operationally connected to the axel; and
an electric motor operationally connected to the axel.

2. The method of claim 1 wherein the regenerative braking axel assembly is disposed on a trailer and wherein the trailer is removably connected to a trailer hitch disposed on the vehicle.

3. The method of claim 2 wherein the trailer is removably connected to a trailer hitch by at least one dampening member.

4. The method of claim 3 wherein the dampening members are used for steering.

5. The method of claim 1 wherein the regenerative braking axel assembly is pivotably connected to an undercarriage of a semi-trailer.

6. The method of claim 1 wherein the vehicle is a motorcycle.

7. The method of claim 1 wherein the vehicle is a school bus.

8. The method of claim 1 wherein the vehicle is a delivery van.

9. The method of claim 1 wherein the regenerative braking axel assembly further comprises a charging port for connection to house current.

10. The method of claim 1 wherein the at least one electromagnetic brake assembly and the electric motor are unitary.

11. A kit, comprising:
a regenerative braking axel assembly;
at least one battery pack operationally connectable to the regenerative braking axel assembly;
an electronic controller operationally connected to the regenerative braking axel assembly and to the at least one battery pack a sensor for detecting amount of braking required and operationally connected to the electronic controller; and
instructions for retrofitting an existing vehicle.

12. The kit of claim 11 and further comprising a heat exchanger for operational connection to a vehicle exhaust, to the regenerative braking axel assembly, and to the battery pack.

13. The kit of claim 11 and further comprising a software patch.

14. A vehicle fitted with a regenerative braking accessory, comprising:
a vehicle,
a regenerative braking accessory operationally connected to the vehicle and further comprising:
an axel;
at least one wheel operationally connected to the axel;
at least one electromagnetic brake assembly operationally connected to the axel;
an electric motor operationally connected to the axel;
a battery array operationally connected to the at least one electromagnetic brake assembly and to the electric motor; and
an electronic controller operationally connected to the battery array, to the at least one electromagnetic brake assembly and to the electric motor.

15. The vehicle fitted with a regenerative braking accessory of claim 14 and further comprising:
a sensor operationally connected to the axel and to the electronic controller; and
a heat exchanger operationally connected to the vehicle, to the electronic controller, to the battery pack, and to the electric motor.

16. The vehicle fitted with a regenerative braking accessory of claim 14 wherein the vehicle has a gas pedal and wherein the electronic controller is operationally connected to the gas pedal to facilitate on demand regenerative braking when the gas pedal is released.

17. The vehicle fitted with a regenerative braking accessory of claim 14 wherein the regenerative braking accessory is supported by a connection framework operationally connected thereto.

18. The vehicle fitted with a regenerative braking accessory of claim 17 wherein the connection framework is a trailer connected to the vehicle.
